(19) United States
(12) Patent Application Publication
(10) Pub. No.: US 2026/0064570 A1
(43) Pub. Date: Mar. 5, 2026

(54) STATEFUL CONTINUOUS INTEGRATION AND CONTINUOUS DEPLOYMENT PIPELINES

(71) Applicant: Red Hat, Inc., Raleigh, NC (US)

(72) Inventors: Shalini Khandelwal, Shahdara (IN); Leigh Griffin, Waterford (IE)

(73) Assignee: Red Hat, Inc., Raleigh, NC (US)

(21) Appl. No.: 18/825,284

(22) Filed: Sep. 5, 2024

(51) Int. Cl. G06F 11/36

(52) U.S. Cl. CPC G06F 11/3684

(57) ABSTRACT

Techniques described herein relate to modifying executions of a stateful continuous integration and continuous deployment (CI/CD) pipeline. For example, a computing system can execute a CI/CD pipeline by applying tasks to a software project. The computing system can store a resulting state produced by each execution of the CI/CD pipeline. For a particular task of the multiple tasks in the CI/CD pipeline, the computing system can determine a repeated status over multiple prior executions of the CI/CD pipeline based on the stored resulting states. The computing system can modify a subsequent execution of the CI/CD pipeline based on the repeated status of the particular task.

### TECHNICAL FIELD

The present disclosure relates generally to continuous integration and continuous deployment pipelines. More specifically, but not by way of limitation, this disclosure relates to stateful continuous integration and continuous deployment pipelines.

### BACKGROUND

Continuous integration is the process of merging developers' working copies of source code into a shared mainline code-base at frequent intervals, such as multiple times a day. Continuous integration is implemented using continuous integration tools, such as Jenkins, Buildbot, or Travis CI. Developers can submit source code at periodic intervals to the continuous integration tool, which can implement a continuous integration pipeline that attempts to produce a build from the source code. A build is executable code that has been successfully created and tested for a piece of software, such as a software application. Generally, the continuous integration pipeline includes multiple phases that are executed in a sequential order. The continuous integration pipeline can begin with a compilation phase in which the source code is compiled into artifacts. Artifacts are executable code that has been compiled from source code for testing. The continuous integration pipeline can then perform a testing phase in which various types of tests (e.g., integration tests, acceptance tests, and unit tests) are executed on the artifacts. The testing phase can enable the developers to rapidly detect defects in the source code, so that they can be corrected as soon as possible.

### BRIEF DESCRIPTION OF THE DRAWINGS

FIG. 1 is a block diagram of an example of a computing environment including stateful continuous integration and continuous deployment (CI/CD) pipelines, according to some aspects of the present disclosure.

FIG. 2 is a block diagram of example executions of a stateful CI/CD pipeline, according to some aspects of the present disclosure.

FIG. 3 is a block diagram of another example of a computing environment including stateful CI/CD pipelines, according to some aspects of the present disclosure.

FIG. 4 is a flowchart of an example of a process for implementing a stateful CI/CD pipeline in a computing environment, according to some aspects of the present disclosure.

### DETAILED DESCRIPTION

A continuous integration and continuous deployment (CI/CD) workflow may include multiple scheduled pipelines that can be used to validate continuous software builds or for corresponding regression testing. Other uses of such pipelines can involve gating validations for periodic (e.g., nightly, weekly, etc.) software builds. Typically, these pipelines may be independent of one another. But the continuous nature of these pipelines may result in several key issues. For instance, the pipelines may consume huge amounts of computing resources, such as RAM, CPU, processing power, etc. Additionally, in many instances, stopping a pipeline may not be an option, which can result in jobs or tasks in the pipeline continuing to fail in each run until manual intervention is performed to address the root cause. This can mean that many jobs or tasks in the pipeline end in failure yet will be run again with no resolution, which can waste computing resources. CI/CD jobs or tasks may intend to solve manual efforts, but in the case of frequent failures, this may add to manual efforts of analyzing the failures. In many cases, failures may be ignored because in fully automated CI/CD workflows, human efforts may be ignored. Further, in some instances, scheduled pipelines may run multiple jobs or tasks, meaning the same jobs may run over and over with no change from run to run, as CI/CD workflows are traditionally stateless. This can waste resources and time to arrive at the same result.

Some examples of the present disclosure can overcome one or more of the issues mentioned above by implementing stateful CI/CD pipelines. By making the pipelines stateful, this can provide the opportunity to analyze generic failures on their own (e.g., isolated from other task or job failures within the same pipeline). Additionally, overall queue times can be sped up by reusing artifacts, testing outputs, and successful runs from other jobs that share the same tasks. Usage of computing resources, particularly RAM and CPU, can be significantly reduced by preventing re-execution of tasks for a portion of a software build that has not changed. Metadata, such as flags, could be set for tasks with the same repeated output over many consecutive runs. These flags could trigger the reuse of artifacts, outputs, etc. Urgent flags may also be set for tasks that have failed more than a threshold number of times to flag high priority issues. When there are already set flags on jobs in the pipeline, human efforts may be minimal. This can result in an optimum CI/CD workflow, which states that there should be minimal human intervention. By saving computational resources on runs that already have predetermined endings, stateful CI/CD workflows can allow for greater reuse of components compared to traditional CI/CD workflows. For example, stateful CI/CD workflows may be a viable mechanism in sensitive scenarios such as automotive or edge computing environments, where there may only be a single possible build attempt due to power constraints or range issues.

In a particular example, a stateful CI/CD workflow may have an autonomous and automatic pipeline that is run every night. The pipeline may have several tasks that are executed in sequence. The state of the pipeline can be stored for a threshold number of earlier runs, such as in cold storage. This can provide a caching-like mechanism with natural degradation over time to ensure that resource utilization stays sensible. The state can include resulting testing outputs (e.g, a pass/fail state, or any other testing output), artifacts, software builds, etc. that were generated as part of executing tasks in the pipeline. A stateful pipeline service can examine an upcoming pipeline run, and based on the stored state of earlier pipeline runs, the stateful pipeline service may set flags for the current pipeline run. The flags may be used to modify the next run of the pipeline.

For example, a green flag may be set for tasks with positive outcomes, such as successful software builds or tests that passed. If the last N pipelines had a green flag for a particular task, in the next pipeline run, the task may not be executed. Instead, the result of the task in prior pipeline runs can be returned. For example, the end status code, produced artifacts, test results, etc. can be retrieved from storage and returned. In some examples, the behavior of the pipeline run can be modified depending on the flag and the job type. For example, in nightly runs where it may be beneficial to conserve resources, execution of the task with N prior green flags may be prevented and stored task results can be returned instead. Or, at release time, where it may be important to run each task regardless of state, the N prior green flags for the task can be ignored and the task can be executed.

A red flag may be set for tasks with negative outcomes, such as unsuccessful software builds, failed tests, etc. If the last N pipelines had a red flag for a particular task, in the next pipeline run, the stateful pipeline service can prompt a user to set an additional flag, such as “needs analysis” or “may need skip.” If the user set such additional flags, the corresponding task can be skipped in the next pipeline run. In some examples, if the last N pipelines had a red flag set for the task, an “urgent” flag may be added to the task. The urgent flag may prevent a user from waiving the results of the task. This may be helpful in gating pipeline runs, where if there are continuous failures in consecutive runs, it may become mandatory to address the failure. The urgent flag may also indicate to users that the task is continuously failing, and that intervention is required. In some examples, the stateful pipeline service may execute autonomous self-healing capabilities to try and remediate the failed task. For example, machine learning may be applied to modify the software project or the build. If the failed task continues to not be addressed (e.g., over N number of pipeline runs), the stateful service pipeline can prevent the task from being executed in a subsequent pipeline run to preserve resources. Instead of executing the task, the pipeline can return the exit logs, code, events, etc. from previous stored executions of the task.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

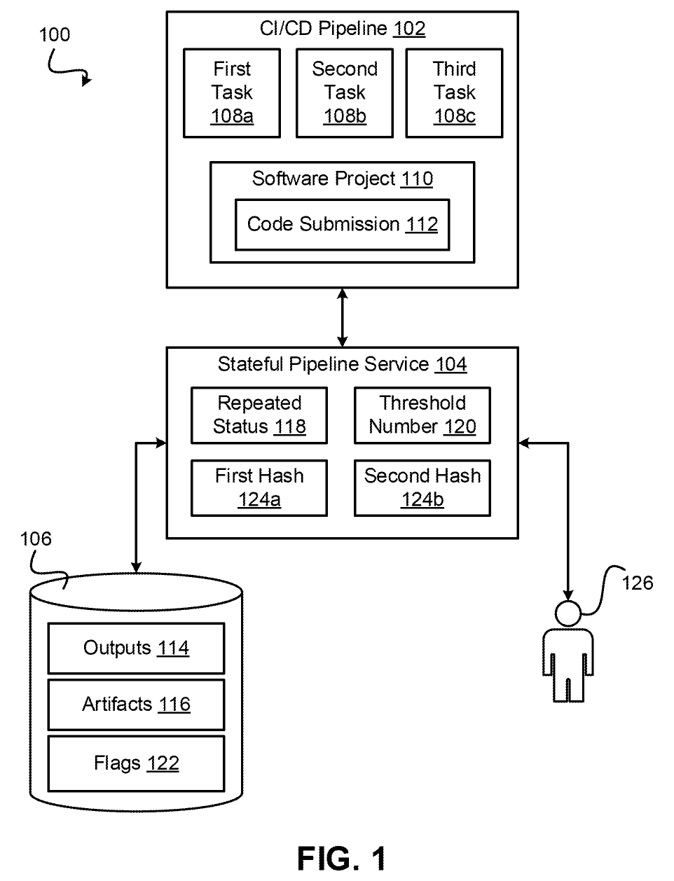

FIG. 1 is a block diagram of an example of a computing environment 100 including stateful continuous integration and continuous deployment (CI/CD) pipelines 102, according to some aspects of the present disclosure. In some examples, the computing environment 100 may be a distributed computing environment that includes multiple devices in communication via a network, such as a local area network or the Internet. Alternatively, the computing environment 100 may be a single device, such as a laptop, desktop, or any other suitable computing device. The computing environment 100 can execute one or more CI/CD pipelines 102 that include tasks 108a-c that are executed in sequence in relation to a software project 110. The computing environment 100 can also include one or more users 126. The users 126 may interact with the computing environment 100 via computing devices (e.g., desktop computers, laptop computers, mobile devices, servers, etc.) on which the users 126 can submit code submissions 112 for the software project 110.

The computing environment 100 can also include a stateful pipeline service 104 and a pipeline state database 106. The stateful pipeline service 104 can store stateful information from each run of the CI/CD pipeline 102 in the pipeline state database 106. For example, tasks 108a-c that are executed with respect to the software project 110 during a run of the CI/CD pipeline 102 can produce outputs 114 (e.g., testing outputs) and artifacts 116 (e.g., software builds such as virtual machines, databases, containers, etc.). In some examples, the pipeline state database 106 can store the state of a threshold number of prior runs of the CI/CD pipeline 102, with older states being removed. In addition to the outputs 114 and artifacts 116, the pipeline state database 106 may also store flags 122 that characterize the outputs 114 and artifacts 116. For example, if the first task 108a was successfully performed, such as applying a test to the software project 110 and producing a passing output 114 to the test, then a green flag may be stored for the first task 108a. If the second task 108b was not successfully performed, such as attempting and failing to compile the code submission 112 into an artifact 116, then a red flag may be stored for the second task 108b. The use of flags 122 is a non-limiting example, as any means of storing metadata that indicates information regarding the execution of tasks 108a-c can be used.

The CI/CD pipeline 102 may, in some examples, be automatically executed with respect to the software project 110 at particular intervals, such as nightly or weekly. The CI/CD pipeline 102 may additionally or alternatively be executed on command (e.g., as prompted by the user 126). The stateful pipeline service 104 may modify execution of the CI/CD pipeline 102 based on the prior states of the CI/CD pipeline 102 stored in the pipeline state database 106. For example, particularly for nightly runs of the CI/CD pipeline 102, portions of the software project 110 may remain unchanged. Thus, it may be beneficial to conserve computing resources by not continuing to perform tasks 108a-c that correspond to such portions of the software project 110.

To modify execution of the CI/CD pipeline 102 based on prior states that are stored in the pipeline state database 106, the stateful pipeline service 104 may determine that a particular task, such as the third task 108c, has had a repeated status 118 over multiple executions of the CI/CD pipeline 102. For example, the third task 108c may involve a test that is performed on an artifact 116 that was produced by executing a prior task (e.g., second task 108b compiling the code submission 112). The output 114 of the test may be a pass result. The stateful pipeline service 104 may determine that, for a threshold number 120 (e.g., one hundred) of previous runs of the CI/CD pipeline 102, the output 114 of the third task 108c produced a pass result. In response, the stateful pipeline service 104 can modify the next execution of the CI/CD pipeline 102 by preventing the third task 108c from being executed and instead returning the output 114 for the third task 108c from a prior execution (e.g., retrieved from the pipeline state database 106). In another example where the third task 108c involves compiling code submissions, artifacts 116 can instead be retrieved from the pipeline state database 106 and returned. This can prevent wasting of resources to arrive at the same end result and improve confidence for release readiness of the software project 110.

In some examples, to validate that it may not be necessary to execute the third task 108c, a first hash 124a of the current iteration of the software project 110 can be determined. A second hash 124b of a previous iteration of the software project 110 in which the third task 108c was passed can also be determined. The stateful pipeline service 104 can compare the first hash 124a and the second hash 124b. If the comparison indicates that the portion of the software project 110 that corresponds to the third task 108c (e.g., the source code that is tested in the third task 108c) remains unchanged, then the stateful pipeline service 104 can proceed with modifying the next execution of the CI/CD pipeline 102.

The stateful pipeline service 104 may also modify subsequent executions of the CI/CD pipeline 102 based on repeated statuses with negative results. For example, the second task 108b may involve compiling a code submission 112 to generate an artifact 116. Successfully generating the artifact 116 may result in a “pass” flag being stored in the pipeline state database 106 in relation to the second task 108b, while failing to generate the artifact 116 may result in a “fail” flag being stored in relation to the second task 108b. The stateful pipeline service 104 may detect that a “fail” flag has been stored for the second task 108b for a threshold number of prior executions of the CI/CD pipeline 102. The stateful pipeline service 104 may therefore modify the next execution of the CI/CD pipeline 102.

For example, if the last threshold number 120 of executions of the second task 108b had a “fail” flag, the stateful pipeline service 104 can set an “urgent” flag to the second task 108b, or to the CI/CD pipeline 102 in general. The “urgent” flag may notify a user that the second task 108b is continuously failing and that intervention is required. Additionally or alternatively, if the last threshold number 120 of executions of the second task 108b had a “fail” flag, the stateful pipeline service 104 can prompt the user 126 to set flags such as “needs analysis” or “may need skip.” Setting of such flags can cause the stateful pipeline service 104 to cause the CI/CD pipeline 102 to skip execution of the second task 108b in the next execution of the CI/CD pipeline 102.

In some examples, if the last threshold number 120 of executions of the second task 108b had an “urgent” flag, the stateful pipeline service 104 may prevent the user 126 from waiving the results of the CI/CD pipeline 102. This may be helpful in gating pipeline runs, such that if there are continuous failures in consecutive runs, it may be mandatory to address such failures. In some examples, if the “fail” flags or “urgent” flags continue to not be addressed (e.g., over a threshold number 120 of executions of the CI/CD pipeline 102), the stateful pipeline service 104 can cause the CI/CD pipeline 102 to prevent execution of the second task 108b to conserve computing resources. Instead, the CI/CD pipeline 102 can return the exit logs, codes, events, etc. that were produced in prior attempts (and retrieved from the pipeline state database 106) to execute the second task 108b.

In some examples, the stateful pipeline service 104 can perform autonomous self-healing operations to try and remediate failing tests, builds, etc. For example, machine learning techniques (e.g., a large language model) may be applied to the software project 110 to try to “heal” the failed output or artifact build, based on the prior states of the CI/CD pipeline executions that are stored in the pipeline state database 106. In an example, a machine learning model may generate an output indicating that, based on past iterations of the software project 110 (or other software projects), changing permissions from read permissions to write permissions for a portion of the software project 110 may allow for successful compilation of source code. The stateful pipeline service 104 may modify the code in the software project 110 accordingly and execute the CI/CD pipeline 102 on the modified code.

New pipelines with different tasks 108a-c or a different order of tasks 108a-c may also be established based on prior executions of the CI/CD pipeline 102. For such a new pipeline, the stateful pipeline service 104 may show a delta between what is already known (e.g., from past executions of the previous CI/CD pipeline) and what is unknown. This can allow for errors and problems to be addressed (e.g., manually or automatically by the stateful pipeline service 104) before the new pipeline is executed. In some examples, this can be accompanied by a graded score showing the health of the new pipeline. For example, the graded score may be a confidence metric of a successful execution of the new pipeline. With known previous runs that can be drawn on, such new pipelines may be highly accurate and may allow for deployment in sensitive scenarios such as automotive environments or edge environments where only one build may be attempted due to power or range issues. In some examples, the stateful pipeline service 104 may additionally tie known pipeline artifacts 116 or outputs 114 into the design of the new pipeline by transposing the requirements of the configuration of the new pipeline and replacing it with the output 114 or artifact 116 (e.g., instead of executing the corresponding task). This can create an opportunity to reimagine the task sequencing.

While FIG. 1 depicts a specific arrangement of components, other examples can include more components, fewer components, different components, or a different arrangement of components than is shown in FIG. 1. For example, the computing environment 100 can include more CI/CD pipelines 102, more or fewer tasks 108a-c per CI/CD pipeline, more or fewer software projects 110, etc. Additionally, any component or combination of components depicted in FIG. 1 can be used to implement the process(es) described herein.

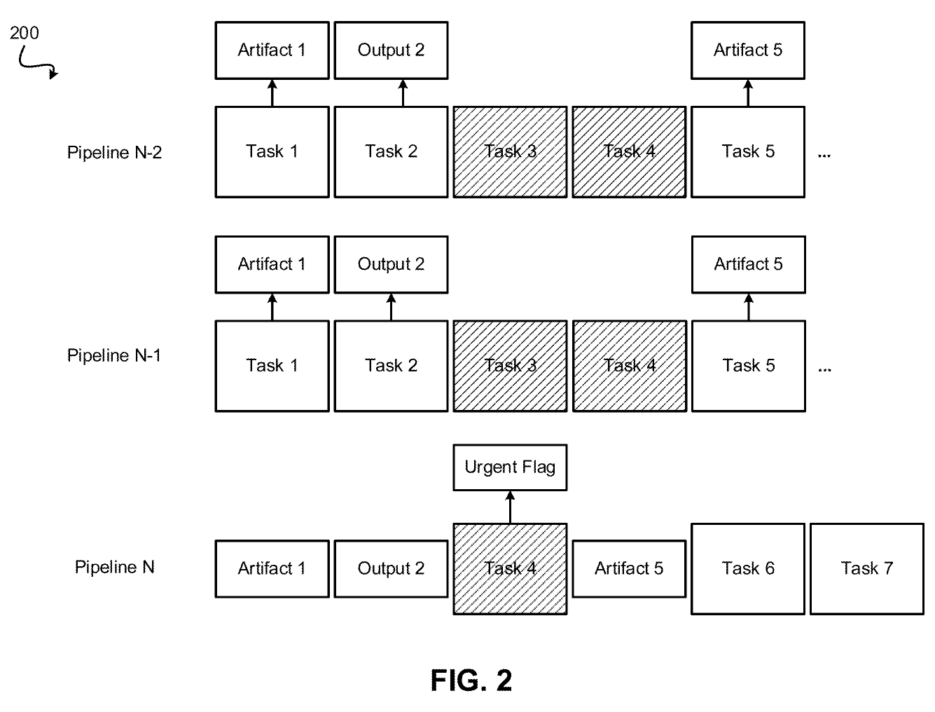

FIG. 2 is a block diagram of example executions of a stateful continuous integration and continuous deployment (CI/CD) pipeline 200, according to some aspects of the present disclosure. The CI/CD pipeline 200 may be an example of the CI/CD pipeline 102 of FIG. 1. FIG. 2 depicts pipeline run N-2, which includes Tasks 1, 2, 3, 4, 5, and subsequent tasks. The shaded tasks (e.g., Task 3 and Task 4) are tasks that failed in their execution. Thus, a red flag may be stored for each of Task 3 and Task 4. Successfully performed Task 1, Task 2, and Task 5 produced Artifact 1, Output 2, and Artifact 5, respectively. Thus, a green flag may be stored for each of Task 1, Task 2, and Task 5. A subsequent pipeline run N-1 may have the same resulting artifacts, outputs, and failed Task 3 and Task 4 as pipeline run N.

As Task 3 may have failed in the previous N-1 executions of the CI/CD pipeline 200 (e.g., as indicated by stored red flags for the previous N-1 executions), it may be beneficial to modify the next run (e.g., pipeline run N). It may be unknown whether the failure of Task 4 is affected by the failure of Task 3. As an attempt to isolate the failure of Task 4, pipeline run N may be modified to not include Task 3. Additionally, Task 1, Task 2, and Task 5 may have had stored green flags for the previous N-1 executions of the CI/CD pipeline 200. Thus, pipeline run N may be modified to replace Task 1 with Artifact 1, replace Task 2 with Output 2, and replace Task 5 with Artifact 5. This can significantly reduce the time and consumption of computing resources involved in executing pipeline run N. In the execution of pipeline run N, Task 4 may fail again. In response, an urgent flag can be applied to Task 4, indicating that Task 4 failed even with the removal of Task 3. The urgent flag may also indicate that Task 4 may require manual intervention.

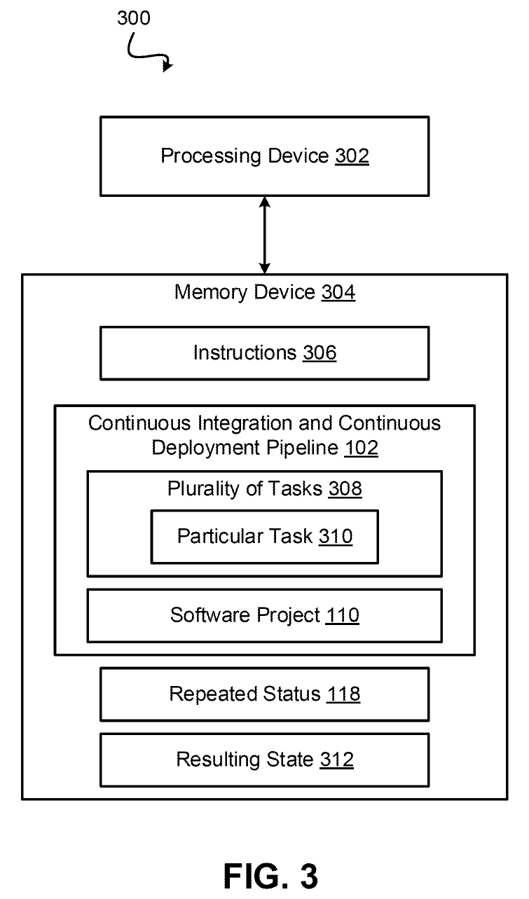

FIG. 3 is a block diagram of another example of a computing environment 300 including a stateful continuous integration and continuous deployment (CI/CD) pipeline, according to some aspects of the present disclosure. The computing environment 300 depicted in FIG. 3 includes a processing device 302 communicatively coupled with a memory device 304. In some examples, the components of the computing environment 300, such as the processing device 302 and the memory device 304, may be part of a same computing device. In other examples, the processing device 302 and the memory device 304 can be included in separate computing devices that are communicatively coupled.

The processing device 302 can include one processing device or multiple processing devices. Non-limiting examples of the processing device 302 include a Field-Programmable Gate Array (FPGA), an application-specific integrated circuit (ASIC), a microprocessor, etc. The processing device 302 can execute instructions 306 stored in the memory device 304 to perform operations. In some examples, the instructions 306 can include processor-specific instructions generated by a compiler or an interpreter from code written in any suitable computer-programming language, such as C, C++, C#, etc.

The memory device 304 can include one memory or multiple memories. The memory device 304 can be non-volatile and may include any type of memory that retains stored information when powered off. Non-limiting examples of the memory device 304 include electrically erasable and programmable read-only memory (EEPROM), flash memory, or any other type of non-volatile memory. At least some of the memory can include a non-transitory computer-readable medium from which the processing device 302 can read instructions 306. The non-transitory computer-readable medium can include electronic, optical, magnetic, or other storage devices capable of providing the processing device with computer-readable instructions or other program code. Examples of the non-transitory computer-readable medium include magnetic disk(s), memory chip(s), ROM, RAM, an ASIC, a configured processor, optical storage, or any other medium from which a computer processor can read the instructions 306.

In some examples, the processing device 302 can execute the instructions 306 to perform some or all of the functionality described herein. For example, the processing device 302 can execute a continuous integration and continuous deployment (CI/CD) pipeline 102 comprising a plurality of tasks 308 applied to a software project 110. The processing device 302 can store a resulting state 312 produced by each execution of the CI/CD pipeline 102. The processing device 302 can determine, for a particular task 310 of the plurality of tasks 308, a repeated status 118 over a plurality of prior executions of the CI/CD pipeline 102 based on the stored resulting state 312. The processing device 302 can modify a subsequent execution of the CI/CD pipeline 102 based on the repeated status 118 of the particular task 310.

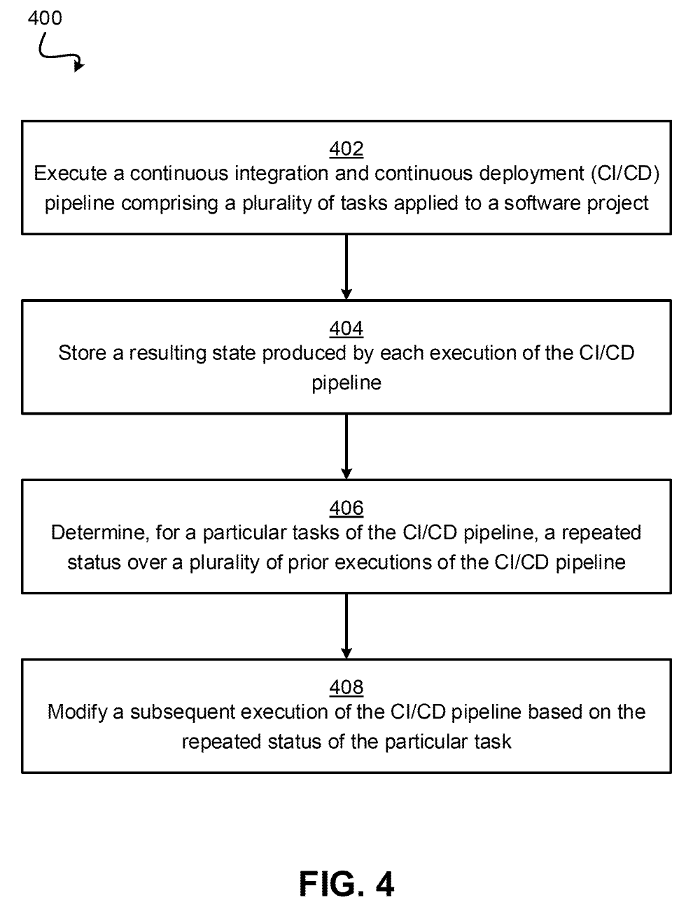

FIG. 4 is a flowchart of an example of a process 400 for implementing a stateful integration pipeline in a computer environment, according to some aspects of the present disclosure. In some examples, the processing device 302 can implement some or all of the steps shown in FIG. 3. Additionally, in some examples, the processing device 302 can be executing the CI/CD pipeline 102, the stateful pipeline service 104, or any suitable component of FIGS. 1-3 to implement some or all of the steps shown in FIG. 4. Other examples can include more steps, fewer steps, different steps, or a different order of the steps than is shown in FIG. 4. The steps of FIG. 4 are discussed below with reference to the components discussed above in relation to FIGS. 1-3.

At block 402, the processing device 302 can execute a continuous integration and continuous deployment (CI/CD) pipeline 102 comprising a plurality of tasks 308 applied to a software project 110. In some examples, the CI/CD pipeline 102 may be automatically run at regular intervals, such as nightly. The plurality of tasks 308 may be performed sequentially in a particular order. The plurality of tasks 308 may involve compiling source code of the software project 110 to produce artifacts 116, testing the source code or the artifacts 116, building the software project 110, or any other appropriate tasks or jobs involved in continuous integration and continuous deployment.

At block 404, the processing device 302 can store a resulting state 312 produced by each execution of the CI/CD pipeline 102. For example, for each execution of the CI/CD pipeline 102, the processing device 302 can store metadata indicating a status of each task of the plurality of tasks 308 applied to the software project 110. For example, the status of each task may involve a code testing output 114 or a software artifact 116 produced by applying the corresponding task to the software project. The output 114 and the artifact 116 themselves can be stored, as well as the metadata. The metadata can be flags or any appropriate annotation indicating whether the corresponding task passed, failed, etc.

At block 406, the processing device 302 can determine, for a particular task 310 of the plurality of tasks 308, a repeated status 118 over a plurality of prior executions of the CI/CD pipeline 102. The repeated status 118 can be determined by determining that the status of the particular task 310 has remained unchanged for more than a threshold number 120 of executions of the CI/CD pipeline 102. For example, the particular task 310 may involve testing an artifact 116 produced from compiling source code of the software project 110. The processing device 302 may determine that, for the last threshold number 120 of runs of the CI/CD pipeline 102, the particular task 310 has had a repeated status 118 of “pass” flags for the test. In another example, the particular task 310 may involve compiling source code to generate an artifact 116, such as a container. The processing device 302 may determine that, for the last threshold number 120 of runs of the CI/CD pipeline 102, the particular task 310 has had a repeated status 118 of “fail” flags for failing to successfully compile the source code to generate the artifact 116.

At block 408, the processing device 302 can modify a subsequent execution of the CI/CD pipeline 102 based on the repeated status 118 of the particular task 310. For example, the repeated status 118 may be a test failure and the corresponding metadata may indicate an intervention requirement for the test failure. Such metadata may be an “urgent” flag. The processing device 302 may detect that a portion of the software project 110 that corresponds to the particular task 310 with the metadata indicating the intervention requirement has not been modified. Then, the processing device 302 may prevent the subsequent execution of the CI/CD pipeline 102 based on detecting that the portion of the software project 110 corresponding to the particular task 310 has not been modified.

In another example, the repeated status 118 (e.g., such as a repeated “failure” flag) may cause the processing device 302 to skip execution of the particular task 310 in the subsequent execution of the CI/CD pipeline 102. This can aid in isolating task failures within the pipeline, such as by demonstrating whether subsequent tasks will fail or succeed if the particular task 310 is skipped. In some examples, the repeated status 119 (e.g., such as a repeated “failure” flag or a repeated “success” flag) may cause the processing device 302 to modify the subsequent execution of the CI/CD pipeline 102 by preventing execution of the particular task 310. The processing device 302 can instead output the repeated status 118 of the particular task 310 in the subsequent execution, such as by returning the output 114 or artifact 116 generated by the particular task 310 in a prior execution of the CI/CD pipeline 102. To validate returning the prior output 114 or artifact 116 (e.g., instead of executing the particular task 310), the processing device 302 may in some examples first compare a first hash 124a of a current iteration of the software project 110 to a second hash 124b of a previous iteration of the software project 110. The processing device 302 may determine, based on the comparison between the first hash 124a and the second hash 124b, that a portion of the software project 110 that corresponds to the particular task 310 has remained unchanged since the prior execution of the CI/CD pipeline 102. Replacement of the particular task 310 with the output 114 or artifact 116 produced by prior execution of the particular task 310 is thus validated.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processing device; and
a non-transitory memory device comprising instructions that are executable by the processing device for causing the processing device to:
execute a continuous integration and continuous deployment (CI/CD) pipeline comprising a plurality of tasks applied to a software project;
store a resulting state produced by each execution of the CI/CD pipeline;
determine, for a particular task of the plurality of tasks and based on the stored resulting state, a repeated status over a plurality of prior executions of the CI/CD pipeline; and
modify a subsequent execution of the CI/CD pipeline based on the repeated status of the particular task.

2. The system of claim 1, wherein the non-transitory memory device further comprises instructions that are executable by the processing device for causing the processing device to:
store the resulting state by, for each execution of the CI/CD pipeline, storing metadata indicating a status of each task of the plurality of tasks applied to the software project; and
determine the repeated status over the plurality of prior executions of the CI/CD pipeline by determining that the status of the particular task has remained unchanged for more than a threshold number of executions.

3. The system of claim 2, wherein the repeated status is a test failure, wherein the metadata for the particular task indicates an intervention requirement for the test failure, and wherein the non-transitory memory device further comprises instructions that are executable by the processing device for causing the processing device to modify the subsequent execution by:
detecting that a portion of the software project corresponding to the particular task with the metadata indicating the intervention requirement has not been modified; and
preventing the subsequent execution of the CI/CD pipeline based on detecting that the portion of the software project corresponding to the particular task has not been modified.

4. The system of claim 2, wherein the status of each task comprises a code testing output or a software artifact produced by applying the corresponding task to the software project.

5. The system of claim 1, wherein the non-transitory memory device further comprises instructions that are executable by the processing device for causing the processing device to modify the subsequent execution of the CI/CD pipeline by:
skipping the particular task in the subsequent execution of the CI/CD pipeline.

6. The system of claim 1, wherein the non-transitory memory device further comprises instructions that are executable by the processing device for causing the processing device to modify the subsequent execution of the CI/CD pipeline by:
preventing execution of the particular task in the subsequent execution of the CI/CD pipeline; and
outputting the repeated status of the particular task in the subsequent execution of the CI/CD pipeline.

7. The system of claim 6, wherein the non-transitory memory device further comprises instructions that are executable by the processing device for causing the processing device to prevent execution of the particular task and output the repeated status of the particular task in the subsequent execution of the CI/CD pipeline in response to:
comparing a first hash of a current iteration of the software project to a second hash of a previous iteration of the software project; and
determining, based on the comparison between the first hash and the second hash, that a portion of the software project corresponding to the particular task has remained unchanged.

8. A method comprising:
executing, by a processing device, a continuous integration and continuous deployment (CI/CD) pipeline comprising a plurality of tasks applied to a software project;
storing, by the processing device, a resulting state produced by each execution of the CI/CD pipeline;
determining, by the processing device and for a particular task of the plurality of tasks and based on the stored resulting state, a repeated status over a plurality of prior executions of the CI/CD pipeline; and
modifying, by the processing device, a subsequent execution of the CI/CD pipeline based on the repeated status of the particular task.

9. The method of claim 8, further comprising:
storing the resulting state by, for each execution of the CI/CD pipeline, storing metadata indicating a status of each task of the plurality of tasks applied to the software project; and
determining the repeated status over the plurality of prior executions of the CI/CD pipeline by determining that the status of the particular task has remained unchanged for more than a threshold number of executions.

10. The method of claim 9, wherein the repeated status is a test failure, wherein the metadata for the particular task indicates an intervention requirement for the test failure, and wherein modifying the subsequent execution further comprises:
detecting that a portion of the software project corresponding to the particular task with the metadata indicating the intervention requirement has not been modified; and
preventing the subsequent execution of the CI/CD pipeline based on detecting that the portion of the software project corresponding to the particular task has not been modified.

11. The method of claim 9, wherein the status of each task comprises a code testing output or a software artifact produced by applying the corresponding task to the software project.

12. The method of claim 8, wherein modifying the subsequent execution of the CI/CD pipeline further comprises:
skipping the particular task in the subsequent execution of the CI/CD pipeline.

13. The method of claim 8, wherein modifying the subsequent execution of the CI/CD pipeline further comprises:
preventing execution of the particular task in the subsequent execution of the CI/CD pipeline; and
outputting the repeated status of the particular task in the subsequent execution of the CI/CD pipeline.

14. The method of claim 13, further comprising preventing execution of the particular task and outputting the repeated status of the particular task in the subsequent execution of the CI/CD pipeline in response to:
comparing a first hash of a current iteration of the software project to a second hash of a previous iteration of the software project; and
determining, based on the comparison between the first hash and the second hash, that a portion of the software project corresponding to the particular task has remained unchanged.

15. A non-transitory computer-readable medium comprising program code that is executable by a processing device for causing a processing device to:
execute a continuous integration and continuous deployment (CI/CD) pipeline comprising a plurality of tasks applied to a software project;
store a resulting state produced by each execution of the CI/CD pipeline;
determine, for a particular task of the plurality of tasks and based on the stored resulting state, a repeated status over a plurality of prior executions of the CI/CD pipeline; and
modify a subsequent execution of the CI/CD pipeline based on the repeated status of the particular task.

16. The non-transitory computer-readable medium of claim 15, further comprising program code that is executable by the processing device for causing the processing device to:
storing the resulting state by, for each execution of the CI/CD pipeline, storing metadata indicating a status of each task of the plurality of tasks applied to the software project; and
determine the repeated status over the plurality of prior executions of the CI/CD pipeline by determining that the status of the particular task has remained unchanged for more than a threshold number of executions.

17. The non-transitory computer-readable medium of claim 16, wherein the status of each task comprises a code testing output or a software artifact produced by applying the corresponding task to the software project.

18. The non-transitory computer-readable medium of claim 15, further comprising program code that is executable by the processing device for causing the processing device to modify the subsequent execution of the CI/CD pipeline by:
skipping the particular task in the subsequent execution of the CI/CD pipeline.

19. The non-transitory computer-readable medium of claim 15, further comprising program code that is executable by the processing device for causing the processing device to modify the subsequent execution of the CI/CD pipeline by:
preventing execution of the particular task in the subsequent execution of the CI/CD pipeline; and
outputting the repeated status of the particular task in the subsequent execution of the CI/CD pipeline.

20. The non-transitory computer-readable medium of claim 19, further comprising program code that is executable by the processing device for causing the processing device to prevent execution of the particular task and output the repeated status of the particular task in the subsequent execution of the CI/CD pipeline in response to:
comparing a first hash of a current iteration of the software project to a second hash of a previous iteration of the software project; and
determining, based on the comparison between the first hash and the second hash, that a portion of the software project corresponding to the particular task has remained unchanged.
